(19) United States
(12) Patent Application Publication
(10) Pub. No.: US 2008/0000502 A1
(43) Pub. Date: Jan. 3, 2008

(54) COMPOSITIONS FOR CLEANING A PROBE CARD AND METHODS OF CLEANING A PROBE CARD USING THE SAME

(75) Inventors: Jung-Dae PARK, Seoul (KR); Seung-Ki CHAE, Seoul (KR); Bo-Yong LEE, Gyeonggi-do (KR); Myoung-Ok HAN, Gyeonggi-do (KR); Jun-Hee LEE, Gyeonggi-do (KR); Se-Yeon KIM, Seoul (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/757,179

(22) Filed: Jun. 1, 2007

(30) Foreign Application Priority Data
Jun. 1, 2006 (KR) 2006-0049280

(51) Int. Cl. B08B 7/00; C11D 3/02; C11D 7/32; C11D 17/00

(52) U.S. Cl. 134/42; 510/108; 510/175; 510/405

(57) ABSTRACT

A composition for cleaning a probe card that may be a part of a semiconductor probe system and a method of cleaning the probe card using the composition is provided. In one embodiment, the composition includes a basic compound, an alcohol compound, and water. The composition for cleaning the probe card may prevent the probe card from being worn away or corroded, and may effectively remove impurities such as aluminum, aluminum oxide, or organic impurities from the probe card.

### CROSS-REFERENCE TO RELATED APPLICATIONS

This application claims priority under 35 U.S.C. § 119 to Korean Patent Application No. 2006-49280, filed on Jun. 1, 2006, the contents of which are herein incorporated by reference.

### BACKGROUND

1. Field of the Invention

Example embodiments of the present invention relate to compositions for cleaning a probe card and methods of cleaning a probe card using the same. More particularly, example embodiments of the present invention relate to compositions for cleaning a probe card that may be a part of a semiconductor probe system and methods of cleaning a probe card using the same.

2. Description of the Related Art

In a semiconductor manufacturing process, an electric die sorting (EDS) process is performed on a semiconductor device to check its performance capabilities. In the EDS process, defects to the semiconductor device are detected by measuring electrical characteristics of the semiconductor device using a probe station. The probe station has a probe card that makes direct contact with the semiconductor device so as to measure electrical characteristics thereof. The probe card is the part of the probe station that makes contact with the semiconductor device (generally through a pad of the semiconductor device) to input or output electrical signals to the semiconductor device. The probe station analyzes the electrical signals to detect defects to the semiconductor device. Probe card are known in the art, such as the one disclosed in Korean Laid-Open Patent Publication No. 1999-62556.

FIG. 1 is a cross-sectional view illustrating a structure of a probe card disclosed in Korean Laid-Open Patent Publication No. 1999-62556.

Referring to FIG. 1, a probe card includes a substrate 116, an opening 114 formed in a central portion of the substrate 116, and probe needles 111. One end portion of each probe needle 111 is attached to the substrate 116 to be electrically connected to a wiring (not shown) formed on the substrate 116. The other end portion of each probe needle 111 faces a semiconductor device to make contact with a pad of the semiconductor device. Electrical characteristics of the semiconductor device are measured through the contact between the probe needles 111 and the pad of the semiconductor device.

When a large number of semiconductor devices are repeatedly inspected using the probe card, the probe card may become contaminated by various impurities. For example, the probe card may become contaminated by metallic impurities such as aluminum originating from the metal pad of the semiconductor device, oxide impurities such as aluminum oxide impurities, or organic impurities. The impurities may hinder the probe card from making contact with the semiconductor device, which deteriorates the reliability of the inspection. Therefore, it is necessary to clean the probe card after it has been used several times to remove residual impurities thereof so as to prevent errors in the defect detection process.

In conventional methods of cleaning a probe card, impurities are removed from a probe needle by rubbing the probe needle against a cleaning wafer having a cleaning paper. In these methods, the probe needle may be damaged or become worn away when numerous cleaning processes are performed. A worn probe needle may make poor contact with the pad of the semiconductor device. In addition, the removal effectiveness of the cleaning wafer may be increased in reverse proportion to an increase in a number of performed cleaning processes.

The probe card may additionally be physically cleaned using CO₂ gas or CO₂ plasma. For example, a method of cleaning the probe card using a reactive ion etching gas is disclosed in Japanese Laid-Open Patent Publication No. 2000-39467. In this method, the probe needle may be cleaned while preventing contact that potentially wears away the probe needle. However, this method has a poor cleaning efficiency and demands a high maintenance cost. Furthermore, an alteration of the probe system may be required.

The probe card may further be chemically cleaned using an organic cleaning solution or a strong acid solution. For example, Korean Laid-Open Patent Publication No. 1999-62556 discloses a method of cleaning the probe card using an aqueous solution of phosphoric acid. The aqueous solution of phosphoric acid has a relatively high cleaning efficiency, but may corrode any parts having metal such as tungsten, gold, or nickel.

### SUMMARY

Example embodiments of the present invention provide compositions for cleaning a probe card that may remove impurities without causing damage to the probe card.

Additional example embodiments of the present invention provide methods of cleaning a probe card using the above-mentioned compositions.

According to one embodiment of the present invention, a composition for cleaning a probe card includes a basic compound, an alcohol compound, and water. Examples of the basic compound may include an alkali hydroxide salt, an ammonium hydroxide salt, a tetraalkylammonium hydroxide, or combinations thereof. Examples of the alcohol compound may include a monoalcohol having 1 to 4 carbon atoms, a diol having 1 to 4 carbon atoms, an aminoalcohol having 1 to 6 carbon atoms, or a combination thereof.

### BRIEF DESCRIPTION OF THE DRAWINGS

The above and other features and advantages of the present invention will become more apparent by describing in detailed example embodiments thereof with reference to the accompanying drawings, in which:

FIG. 1 is a cross-sectional view illustrating a structure of a conventional probe card;

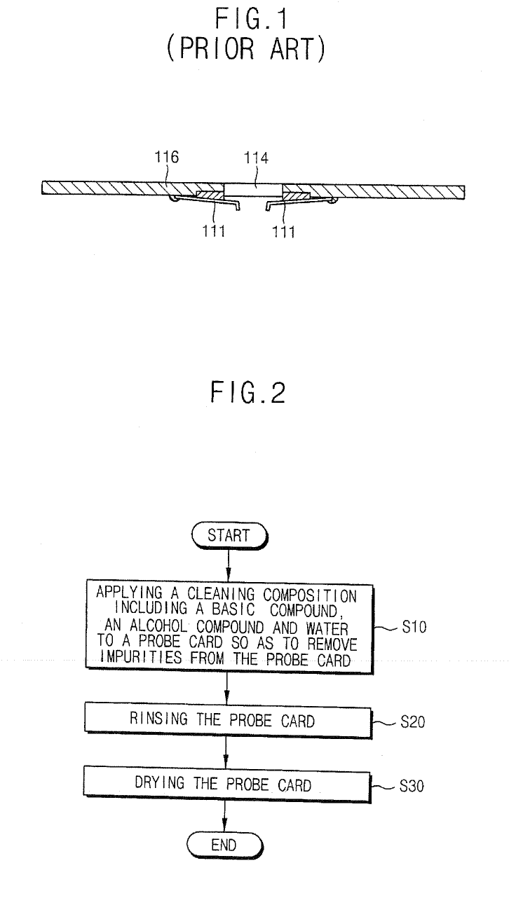

FIG. 2 is a flow chart illustrating a method of cleaning a probe card using a composition for cleaning a probe card in accordance with an example embodiment of the present invention;

FIGS. 3 to 6 are microscopic pictures showing surfaces of a probe needle before and after cleaning the probe needle using a cleaning composition prepared in Example 5; and

FIGS. 7 to 10 are microscopic pictures showing surfaces of a probe needle before and after cleaning the probe needle using a cleaning composition prepared in Comparative Example 1.

### DETAILED DESCRIPTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the present invention are described herein with reference to cross-section illustrations that are schematic illustrations of idealized embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

First Composition for Cleaning a Probe Card

A first composition for cleaning a probe card includes a basic compound, an alcohol compound, and water. As discussed above, when semiconductor devices are repeatedly inspected using the probe card, the probe card may be contaminated by impurities such as aluminum, aluminum oxide, or organic impurities. Particularly, the probe card includes a probe needle that makes direct contact with an object to be inspected. During this inspection, the probe needle may become contaminated by impurities from the object inspected or the test environment. The first composition for cleaning a probe card may remove these impurities from the probe card with a high efficiency, and may prevent the probe card from being worn away or damaged during the cleaning process.

The basic compound included in the first composition for cleaning a probe card may dissolve impurities such as aluminum or aluminum oxide that may remain on the probe card from the inspection process. Examples of the basic compound that may be used in the first composition for cleaning a probe card may include an alkali hydroxide salt, ammonium hydroxide, a tetraalkylammonium hydroxide, and the like. These can be used alone or in a combination thereof. Particular examples of the basic compound may include sodium hydroxide, potassium hydroxide, ammonium hydroxide, tetramethylammonium hydroxide, tetraethylammonium hydroxide, tetrapropylammonium hydroxide, and the like.

When the first composition for cleaning the probe card includes less than about 0.01 percent by weight of the basic compound, the efficiency of removing the impurities from the probe card may be unpreferably deteriorated. In addition, when the amount of the basic compound is greater than about 10 percent by weight, a metallic component of the probe card may be corroded by the composition, and the probe card may be unpreferably damaged. Thus, in accordance with an example embodiment of the present invention, the first composition for cleaning the probe card may include the basic compound in a range of about 0.01 to about 10 percent by weight, and preferably in a range of about 0.02 to about 7 percent by weight based on the total weight of the first composition.

The alcohol compound included in the first composition for cleaning the probe card may easily dissolve organic impurities remaining on the probe card from the inspection process. Furthermore, the alcohol compound may prevent the metallic component of the probe needle from being corroded by the composition.

Examples of the alcohol compound that may be used in the first composition for cleaning the probe card may include a monoalcohol having 1 to 4 carbon atoms, a diol having 1 to 4 carbon atoms, an aminoalcohol having 1 to 6 carbon atoms, and the like. These may be used alone or in a combination thereof. Particular examples of the alcohol compound may include one or more of methanol, ethanol, propanol, butanol, ethylene glycol, propanediol, butanediol, monoethanolamine, diethanolamine, triethanolamine, propanolamine, and the like.

When the first composition for cleaning the probe card includes less than about 0.1 percent by weight of the alcohol compound, the removal efficiency for organic impurities may be reduced and the metallic component of the probe needle may be unpreferably corroded by the composition. In addition, when the amount of the alcohol compound is greater than about 5 percent by weight, the removal efficiency for the organic impurities may not be substantially improved, which is also undesirable. Thus, in accordance with an example embodiment of the present invention, the first composition for cleaning the probe card may include the alcohol compound in a range of about 0.1 to about 5 percent by weight, and preferably in a range of about 0.5 to about 4 percent by weight.

The first composition for cleaning the probe card includes water such as deionized water, pure water, ultra pure water, etc. The amount of water included in the first composition for cleaning the probe card may be properly adjusted considering a removal efficiency of the impurities, a corroded degree of the metallic component in the probe card, or concentrations of the basic compound and the alcohol compound.

Second Composition for Cleaning a Probe Card

A second composition for cleaning a probe card includes a basic compound, an alcohol compound, a surfactant, and water. The second composition may be substantially the same as the first composition except that the second composition further includes the surfactant. Thus, explanations for the basic compound, the alcohol compound, and water included in the second composition will be omitted herein for brevity.

The surfactant included in the second composition may assist the composition to permeate into the impurities attached to the probe needle. Thus, the removal efficiency for the impurities may be enhanced.

Examples of the surfactant that may be used in the second composition for cleaning the probe card may include a nonionic surfactant, an anionic surfactant, or a combination thereof. Examples of the nonionic surfactant may include a copolymer of polyethylene oxide and polypropylene oxide, or a block copolymer of polyethylene glycol and polypropylene glycol. Particular examples of the nonionic surfactant may include NCW (a trade name manufactured by Wako Pure Chemical Industries, Ltd., Japan), Synperonic PE/F68, Synperonic PE/L61, Synperonic PE/L64 (trade names manufactured by Fluka Chemie GmbH, Germany), etc. An example of the anionic surfactant may include FSP (a trade name manufactured by DuPont, U.S.A.).

When the second composition for cleaning the probe card includes less than about 0.001 percent by weight of the surfactant, the composition may not easily permeate into the impurities attached to the probe needle so that a removal efficiency of the impurities may be reduced. In addition, when the amount of the surfactant is greater than about 0.1 percent by weight, the removal efficiency of impurities may not be substantially improved and the surfactant may unpreferably remain on the probe card after the cleaning process is performed. Thus, in accordance with an example embodiment of the present invention, the second composition for cleaning the probe card may include the surfactant in a range of about 0.001 to about 0.1 percent by weight, and preferably in a range of about 0.002 to about 0.08 percent by weight based on the total weight of the second composition.

In an example embodiment of the present invention, the second composition for cleaning the probe card may include about 0.01 to about 10 percent by weight the basic compound, about 0.1 to about 5 percent by weight of the alcohol compound, about 0.001 to about 0.1 percent by weight of the surfactant, and a remainder of water.

Third Composition for Cleaning a Probe Card

A third composition for cleaning a probe card includes a basic compound, an alcohol compound, an oxidizing agent, and water. The third composition may be substantially the same as the first composition except that the third composition further includes the oxidizing agent. Thus, explanations for the basic compound, the alcohol compound, and water included in the third composition will be omitted herein for brevity.

The oxidizing agent included in the third composition for cleaning a probe card may chemically oxidize impurities such as aluminum or organic impurities that remain on the probe card after an inspection process to thereby promote dissolution of the impurities into the composition. Additionally, the oxidizing agent may form a thin oxide film on the probe needle to prevent the probe needle from being corroded or damaged by the composition.

Examples of the oxidizing agent that may be used in the third composition for cleaning the probe card may include one or more of ammonium nitrate, ammonium sulfate, and the like. These can be used alone or in a combination thereof.

When the third composition for cleaning the probe card includes less than about 0.001 percent by weight of the oxidizing agent, a removal efficiency of the impurities may be reduced unpreferably. In addition, when the amount of the oxidizing agent is greater than about 1 percent by weight, the probe needle may be excessively oxidized or damaged. Thus, in accordance with an example embodiment of the present invention, the third composition for cleaning the probe card may include the oxidizing agent in a range of about 0.001 to about 1 percent by weight, and preferably about 0.1 to about 0.8 percent by weight based on a total weight of the third composition.

In an example embodiment of the present invention, the third composition for cleaning the probe card may include about 0.01 to about 10 percent by weight of the basic compound, about 0.1 to about 5 percent by weight of the alcohol compound, about 0.001 to about 1 percent by weight of the oxidizing agent, and a remainder of water.

Fourth Composition for Cleaning a Probe Card

A fourth composition for cleaning a probe card includes a basic compound, an alcohol compound, a surfactant, an oxidizing agent, and water. The fourth composition may be substantially the same as the first composition except that the fourth composition further includes the surfactant and the oxidizing agent. Thus, explanations for the basic compound, the alcohol compound, and water included in the fourth composition will be omitted herein for brevity. Additionally, the surfactant and the oxidizing agent included in the fourth composition are substantially the same as those used in the second composition and the third composition, respectively, so any further explanations in these regards will be omitted herein.

In an example embodiment of the present invention, the fourth composition for cleaning the probe card may include about 0.01 to about 10 percent by weight of the basic compound, about 0.1 to about 5 percent by weight of the alcohol compound, about 0.001 to about 0.1 percent by weight of the surfactant, about 0.001 to about 1 percent by weight of the oxidizing agent, and a remainder of water.

As mentioned above, the first to the fourth compositions for cleaning the probe card may remove the impurities from the probe card with a high efficiency, and may prevent the probe card from being worn away or damaged in the cleaning process. Therefore, errors in detecting a defect of a semiconductor device may be substantially reduced or prevented, and a reliability of an inspection process may be improved. Furthermore, a durability of the high-priced probe card may be enhanced to cut costs of the inspection process.

A method of cleaning a probe card in accordance with an example embodiment of the present invention will be fully described with reference to the accompanying drawings, hereinafter.

Method of Cleaning a Probe Card

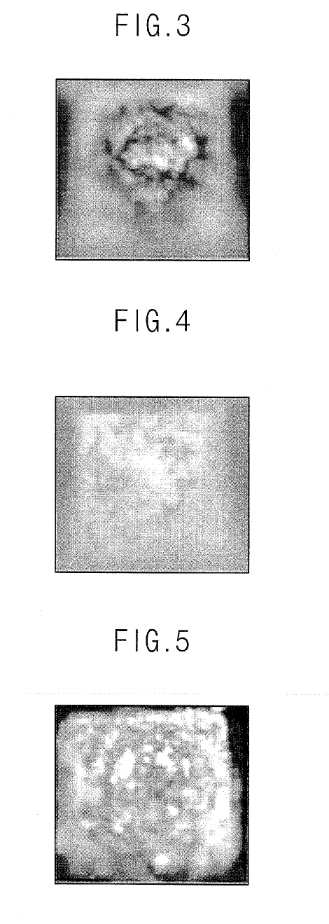

FIG. 2 is a flow chart illustrating a method of cleaning a probe card using a composition for cleaning a probe card in accordance with an example embodiment of the present invention.

Referring to FIG. 2, the composition for cleaning a probe card according to an example embodiment of the present invention is applied to the probe card that may be contaminated by impurities to thereby remove the impurities from the probe card in step S10.

The probe card, which is the object to be cleaned, may be a part of a probe station for a semiconductor device that may be used in an electric die sorting (EDS) process. The probe card may include a substrate having a wiring thereon and one or more probe needles that may be electrically connected to the wiring. The probe needle may include a body portion positioned at one end of the probe needle and a tip portion located at the other end of the probe needle. The body portion of the probe needle may be attached to the substrate of the probe card. The probe needle may make direct contact with an object to be inspected and may exchange an electrical signal with the object. The probe needle may include a conductive material. For example, the tip portion may include tungsten as a main component, and the body portion may include one or more metal components, such as gold, nickel, lead, rhodium, etc. Examples of the probe needle may include a probe needle having an MEMS type (manufactured by FormFactor Inc.) and a probe needle having a Cantilever type (manufactured by HAWK).

When a large number of semiconductor devices are repeatedly inspected using the probe card, the probe card may be contaminated by various impurities. Examples of the impurities may include aluminum, aluminum oxide, organic impurities, or combinations thereof.

The first to fourth compositions according to the present invention may be used for cleaning the probe card contaminated by the impurities. The first to fourth cleaning compositions commonly include a basic compound, an alcohol compound, and water. The basic compound may dissolve the impurities including aluminum or aluminum oxide that remain on the probe card to help remove the impurities from the probe card. The alcohol compound may dissolve or remove organic impurities from the probe card and may help prevent the metallic component of the probe card from being corroded. The compositions for cleaning the probe card are previously described above, so any further explanations in these regards will be omitted herein for brevity.

In an example embodiment of the present invention, a probe card contaminated by impurities may be cleaned by immersing the probe card into the composition. When cleaning efficiency is considered, the composition for cleaning the probe card may be applied to the probe card at a temperature of about 20° C. to about 40° C. for about 5 to about 30 minutes.

In an example embodiment of the present invention, the probe card may be rinsed with water in step S20 after the composition is applied to the probe card. For example, the probe card, on which a cleaning process is performed, may be rinsed by immersing it into ultra pure water for about 5 minutes. As a result, any residual cleaning composition and/or impurities may be substantially removed from the probe card. Additionally, the rinsed probe card may be dried using an inactive gas such as argon or nitrogen in step S30.

When the probe card is cleaned using the composition according to an example embodiment of the present invention, the impurities may be removed from the probe card with a high efficiency, and the probe card may be prevented from being worn away or being damaged in the cleaning process. Therefore, errors in detecting a defect of a semiconductor device may be substantially reduced or prevented, and the reliability of an inspection process may be improved. Furthermore, the durability of the high-priced probe card may be enhanced to cut costs of the inspection process.

The present invention will be further described through Examples and Comparative Examples, hereinafter. The Examples and Comparative Examples set forth herein are illustrative of the present invention and are not to be construed as limiting as the present invention may be embodied in many different forms.

Preparation of Composition for Cleaning a Probe Card

### EXAMPLE 1

About 1 percent by weight of 1N sodium hydroxide (NaOH) aqueous solution, about 1 percent by weight of monoethanolamine (MEA), and about 98 percent by weight of deionized water were mixed together at room temperature (about 27° C.) for about 30 minutes until the mixture became transparent. As a result, a composition for cleaning a probe card was obtained.

### EXAMPLES 2 to 10

Compositions for cleaning a probe card were prepared by performing processes substantially the same as those in Example 1 except for types and amounts of the basic compound and the alcohol compound, or use of a surfactant and/or an oxidizing agent. In the preparation of the compositions, 1N NaOH aqueous solution, ammonium hydroxide (NH₄OH) aqueous solution having about 29 percent of concentration or tetramethylammonium hydroxide (TMAH) aqueous solution having about 20 percent of concentration was used as the basic compound. Monoethanolamine (MEA) or ethylene glycol (EG) was used as the alcohol compound. A nonionic surfactant such as NCW (a trade name manufactured by Wako Chemical, Ltd., Japan) or an anionic surfactant such as FSP (a trade name manufactured by DuPont, U.S.A.) was used. Ammonium nitrate (NH₄NO₃) was used as the oxidizing agent. Types and amounts of components used in preparing the cleaning compositions are shown in Table 1. The unit of the amount is percent by weight.

When the surfactant and/or the oxidizing agent were used in the preparation, the resulting mixture was additionally stirred for about two hours to sufficiently dissolve the surfactant and/or the oxidizing agent in water.

### COMPARATIVE EXAMPLES 1 to 4

Compositions for cleaning a probe card were prepared by mixing the basic compound and water. Types and amounts of components used in preparing the cleaning compositions are shown in Table 1. The unit of the amount is percent by weight.

TABLE 1

| | Basic | | Alcohol | | | | | | |
|---|---|---|---|---|---|---|---|---|---|
| | Compound | | Compound | | Surfactant | | Oxidizing Agent | | Water |
| Example 1 | NaOH | 1 | MEA | 1 | — | | — | | 98 |
| Example 2 | NaOH | 1 | EG | 1 | — | | — | | 98 |
| Example 3 | NaOH | 1 | EG | 1 | NCW | 0.01 | — | | 97.99 |
| Example 4 | NaOH | 1 | EG | 1 | FSP | 0.01 | NH₄NO₃ | 0.5 | 97.49 |
| Example 5 | NaOH | 1 | EG | 1 | NCW | 0.01 | NH₄NO₃ | 0.5 | 97.49 |
| Example 6 | NH₄OH | 1 | EG | 1 | NCW | 0.01 | — | | 97.99 |
| Example 7 | NH₄OH | 5 | EG | 3 | NCW | 0.01 | NH₄NO₃ | 0.5 | 91.49 |
| Example 8 | TMAH | 1 | EG | 1 | NCW | 0.01 | — | | 97.99 |
| Example 9 | TMAH | 5 | EG | 3 | NCW | 0.01 | NH₄NO₃ | 0.5 | 91.49 |
| Example 10 | TMAH | 1 | EG | 1 | — | | NH₄NO₃ | 0.5 | 97.5 |
| Comparative | NaOH | 1 | — | — | — | | | | 99 |
| Example 1 | | | | | | | | | |
| Comparative | NaOH | 5 | — | — | — | | | | 95 |
| Example 2 | | | | | | | | | |
| Comparative | NH₄OH | 1 | — | — | — | | | | 99 |
| Example 3 | | | | | | | | | |
| Comparative | TMAH | 1 | — | — | — | | | | 99 |
| Example 4 | | | | | | | | | |

Evaluation of Cleaning Ability

Cleaning abilities of the compositions prepared in Examples and Comparative Examples were then evaluated.

To estimate the cleaning abilities for the compositions, probe cards contaminated by impurities such as aluminum, aluminum oxide, and organic impurities were cleaned by immersing the probe cards into the cleaning compositions at room temperature for about 20 minutes. Before and after performing the cleaning process, tip portions of the probe cards were observed using a microscope to confirm the amounts of residual impurities. The cleaning abilities for the compositions were then estimated by using the probe card having a probe needle having an MEMS type (manufactured by FormFactor Inc.) or a probe needle having a Cantilever type (manufactured by HAWK). The results are shown in Table 2.

TABLE 2

Cleaning Ability

| | MEMS Type | Cantilever Type |
|---|---|---|
| Example 1 | Δ | Δ |
| Example 2 | Δ | Δ |
| Example 3 | Δ | ◯ |
| Example 4 | Δ | Δ |
| Example 5 | ⊚ | ⊚ |
| Example 6 | ◯ | ◯ |
| Example 7 | ⊚ | ⊚ |
| Example 8 | ⊚ | ⊚ |
| Example 9 | ⊚ | ◯ |
| Comparative Example 1 | Δ | Δ |

In the Table 2, ⊚, O and Δ represent “Excellent,” “Good,” and “Ordinary,” respectively. “Excellent” means that the impurities are completely removed, “Good” indicates that most of the impurities are removed and a very small amount of the impurities remains on the probe card, and “Ordinary” represents that some impurities remain on the probe card.

As shown in Table 2, it was confirmed that the compositions for cleaning the probe card according to the present invention had excellent or above average abilities for removing the impurities from the probe card. In addition, the compositions prepared in Examples 3 to 9, which further included the surfactant and/or the oxidizing agent, exhibited better cleaning abilities than the compositions prepared in Examples 1 and 2, which only included the basic compound, the alcohol compound, and water.

Particularly, when the compositions prepared in Examples 2 and 3 were compared with each other, the composition prepared in Example 3 further including the surfactant showed a superior cleaning ability than the composition prepared in Example 2. When the compositions prepared in Examples 2 and 5 were compared with each other, the composition prepared in Example 5 further including both the surfactant and the oxidizing agent exhibited a much superior cleaning ability than the composition prepared in Example 2. Furthermore, it was confirmed that the compositions prepared in Examples 7 and 8, which included ammonium hydroxide or tetramethylammonium hydroxide as the basic compound, had excellent abilities for removing the impurities such as aluminum, organic impurities, and aluminum oxide.

It was also observed that the compositions prepared in Example 1 and Comparative Example 1 did not clearly remove aluminum-based impurities from the probe card. However, the composition prepared in Example 1 further including the alcohol compound showed an enhanced ability for removing organic impurities compared with the composition prepared in Comparative Example 1.

Although it is not shown in Table 2, the compositions prepared in Comparative Examples 2 to 4 showed cleaning abilities similar to those of the composition prepared in Comparative Example 1, and the composition prepared in Example 10 exhibited a good cleaning ability.

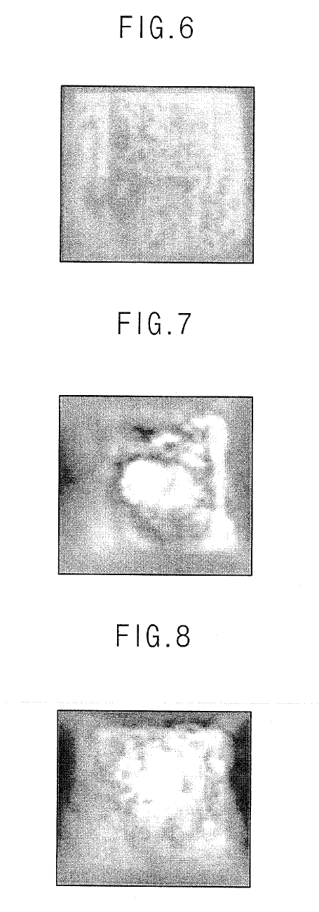

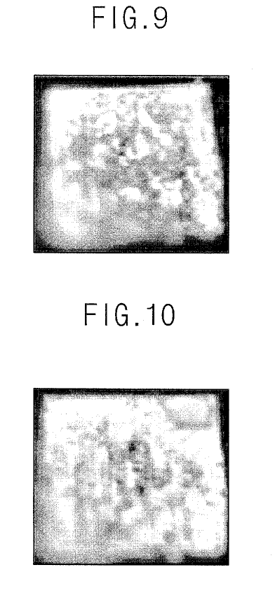

FIGS. 3 to 6 are microscopic pictures showing surfaces of the probe needle before and after cleaning the probe needle using the cleaning composition prepared in Example 5. FIGS. 7 to 10 are microscopic pictures showing surfaces of the probe needle before and after cleaning the probe needle using the cleaning composition prepared in Comparative Example 1.

Particularly, FIGS. 3 and 4 are microscopic pictures showing surfaces of the probe needle having the MEMS type before and after cleaning the probe needle using the composition prepared in Example 5, respectively. FIGS. 5 and 6 are microscopic pictures showing surfaces of the probe needle having the Cantilever type before and after cleaning the probe needle using the composition prepared in Example 5, respectively. Furthermore, FIGS. 7 and 8 are microscopic pictures showing surfaces of the probe needle having the MEMS type before and after cleaning the probe needle using the composition prepared in Comparative Example 1, respectively. FIGS. 9 and 10 are microscopic pictures showing surfaces of the probe needle having the Cantilever type before and after cleaning the probe needle using the composition prepared in Comparative Example 1, respectively.

Referring to FIGS. 3 to 6, it may be noted that the composition prepared in Example 5 clearly removed most of aluminum-based impurities from the probe needle having the MEMS type and the Cantilever type. Referring to FIGS. 7 to 10, however, aluminum-based impurities having a silver color, which remain on a center portion of the probe needle, are observed. Thus, it may be confirmed that the composition prepared in Comparative Example 1 does not remove most of the aluminum-based impurities, but the composition according to the present invention may effectively remove the aluminum-based impurities.

Evaluation of Damage to a Probe Needle

Damages to a probe needle were also evaluated for the compositions prepared in Examples and Comparative Examples.

The probe needles were cleaned by a process substantially the same as the cleaning process performed in the evaluation of the cleaning abilities.

After the probe needles having the MEMS type and the probe needle having the Cantilever type were cleaned using the compositions, the surfaces of the probe needles were observed using a microscope to determine damages to the probe needles. A tip portion of the probe needle having the MEMS type includes tungsten, and a body portion thereof includes a metal such as nickel, gold, and lead. The probe needle having the Cantilever type includes a tip portion of tungsten and a body portion of nickel.

In addition to the microscopic observations of the surface, the amount of a metal dissolved in the composition was estimated. After the tip portion of the probe needle was partially removed, the removed tip portion was immersed into the compositions. The dissolved amounts of metallic components were measured.

The evaluated results on damages to the probe needle and the dissolved amounts of metal are shown in Table 3.

TABLE 3

| | Damage to | | Dissolved Amount | |
|---|---|---|---|---|
| | Probe Needle | | of Metal [ppb] | |
| | | Cantilever | | Cantilever |
| | MEMS Type | Type | MEMS Type | Type |
| Example 1 | Δ | Δ | 23.68 | 40.94 |
| Example 2 | Δ | Δ | 5.64 | 4.48 |
| Example 3 | Δ | Δ | 0.01 | 0.61 |
| Example 4 | ◯ | ◯ | — | — |
| Example 5 | ◯ | ◯ | 0.63 | — |
| Example 6 | ◯ | ◯ | — | — |
| Example 7 | ⊚ | ⊚ | 0.00 | — |
| Example 8 | ⊚ | ⊚ | 0.00 | — |
| Example 9 | ◯ | Δ | 0.93 | — |
| Comparative | X | X | — | — |
| Example 1 | | | | |

In the Table 3, ⊚ indicates no damage, O means slight damage, Δ denotes partial damage, and X represents severe damage.

As shown in Table 3, the composition prepared in Comparative Example 1 generated severe damages to the probe needle. However, the compositions prepared in Examples 1 to 9 caused only slight or partial damage to the probe needle at most.

Particularly, it was noted that the composition prepared in Example 2 and including ethylene glycol dissolved the metallic components of the probe needle less than the composition prepared in Example 1 and including monoethanolamine did. Additionally, the compositions prepared in Examples 3 to 9 and including the surfactant and/or the oxidizing agent generated relatively less damage to the probe needles and dissolved far less of the metallic components than the compositions in the other Examples. The composition prepared in Example 7, which included ammonium hydroxide, the surfactant, and ammonium nitrate, caused no damage to the probe needle and no dissolution of the metallic components. The composition prepared in Example 8, which included tetramethylammonium hydroxide and the surfactant, also showed no signs of damage to the probe needle and no dissolution of the metallic components. Therefore, it may be noted that the composition for cleaning the probe card in accordance with the present invention may effectively remove impurities from the probe card and also prevent damage to the probe card.

According to the present invention, the composition for cleaning the probe card may remove the impurities such as aluminum, aluminum oxide, or organic impurities from the probe card with a high efficiency, and may prevent the probe card from being worn away or damaged during the cleaning process. Therefore, errors in detecting defects to a semiconductor device may be substantially reduced or prevented, and thus the reliability of an inspection process may be improved. Furthermore, the durability of the high-priced probe card may be enhanced to cut costs of the inspection process.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. Thus, the present invention is to be defined by the following claims, with equivalents of the claims to be included as well.

What is claimed is:

1. A composition for cleaning a probe card, the composition comprising a basic compound, an alcohol compound, and water.

2. The composition of claim 1, wherein the composition comprises about 0.01 to about 10 percent by weight of the basic compound, about 0.1 to about 5 percent by weight of the alcohol compound, and a remainder of water.

3. The composition of claim 1, wherein the basic compound comprises at least one selected from the group consisting of an alkali hydroxide salt, an ammonium hydroxide, and a tetraalkylammonium hydroxide.

4. The composition of claim 1, wherein the alcohol compound comprises at least one selected from the group consisting of a monoalcohol having 1 to 4 carbon atoms, a diol having 1 to 4 carbon atoms, and an aminoalcohol having 1 to 6 carbon atoms.

5. The composition of claim 1, further comprising a surfactant.

6. The composition of claim 5, wherein the composition comprises about 0.01 to about 10 percent by weight of the basic compound, about 0.1 to about 5 percent by weight of the alcohol compound, about 0.001 to about 0.1 percent by weight of the surfactant, and a remainder of water.

7. The composition of claim 1, further comprising an oxidizing agent.

8. The composition of claim 7, wherein the composition comprises about 0.01 to about 10 percent by weight of the basic compound, about 0.1 to about 5 percent by weight of the alcohol compound, about 0.001 to about 1 percent by weight of the oxidizing agent, and a remainder of water.

9. The composition of claim 7, wherein the oxidizing agent comprises at least one of ammonium nitrate and ammonium sulfate.

10. The composition of claim 1, further comprising a surfactant and an oxidizing agent.

11. The composition of claim 10, wherein the composition comprises about 0.01 to about 10 percent by weight of the basic compound, about 0.1 to about 5 percent by weight of the alcohol compound, about 0.001 to about 0.1 percent by weight of the surfactant, about 0.001 to about 1 percent by weight of the oxidizing agent, and a remainder of water.

12. A method of cleaning a probe card, comprising:
applying a cleaning composition to a probe card contaminated by impurities to remove the impurities from the probe card, the cleaning composition including a basic compound, an alcohol compound, and water.

13. The method of claim 12, wherein the impurities comprise one or more of the group consisting of aluminum, aluminum oxide, and organic impurities.

14. The method of claim 12, wherein the probe card comprises a probe needle including at least one metal selected from the group consisting of tungsten, gold, nickel, lead, and rhodium.

15. The method of claim 12, wherein the cleaning composition is applied to the probe card at a temperature of about 20° C. to about 40° C.

16. The method of claim 12, wherein the composition comprises:
about 0.01 to about 10 percent by weight of ammonium hydroxide;
about 0.1 to about 5 percent by weight of ethylene glycol;
about 0.001 to about 0.1 percent by weight of a nonionic surfactant;
about 0.001 to about 1 percent by weight of ammonium nitrate; and
a remainder of water.

17. The method of claim 12, wherein the composition comprises:
about 0.01 to about 10 percent by weight of tetramethylammonium hydroxide;
about 0.1 to about 5 percent by weight of ethylene glycol;
about 0.001 to about 0.1 percent by weight of a nonionic surfactant; and
a remainder of water.

18. A composition for cleaning a probe card, the composition comprising:
about 0.01 to about 10 percent by weight of ammonium hydroxide;
about 0.1 to about 5 percent by weight of ethylene glycol;
about 0.001 to about 0.1 percent by weight of a nonionic surfactant;
about 0.001 to about 1 percent by weight of ammonium nitrate; and
a remainder of water.

19. A composition for cleaning a probe card, the composition comprising:
about 0.01 to about 10 percent by weight of tetramethylammonium hydroxide;
about 0.1 to about 5 percent by weight of ethylene glycol;
about 0.001 to about 0.1 percent by weight of a nonionic surfactant; and
a remainder of water.
